(19) United States
(12) Patent Application Publication
(10) Pub. No.: US 2025/0102697 A1
(43) Pub. Date: Mar. 27, 2025

(54) FLUID SENSOR

(71) Applicant: Fluid Handling LLC., Morton Grove, IL (US)

(72) Inventors: Zijian ZHAO, Cambridge (GB); Vicenzo PIAZZA, Newmarket (GB); William GELL, Skaneateles, NY (US)

(21) Appl. No.: 18/730,161

(22) PCT Filed: Jan. 17, 2023
(86) PCT No.: PCT/GB2023/050075

§ 371 Date: Jul. 18, 2024

(30) Foreign Application Priority Data
Jan. 18, 2022 (GB) 2200588.8

(51) Int. Cl. G01V 3/08; G05D 7/06

(52) U.S. Cl. CPC G01V 3/088; G05D 7/0676

(57) ABSTRACT

A fluid sensor (15) is disclosed. The sensor comprises a frame (21), first and second electrodes (271, 272) supported by the frame and separated by space occupiable by a fluid, and a third electrode (273) lying in a path (29) on the frame between the first and second electrodes.

### FIELD

The present invention relates to a fluid sensor.

### BACKGROUND

Capacitive fluid detectors are known, and examples of such devices can be found in EP 0 378 304 A2, US 2020/0378915 A1, U.S. Pat. No. 6,490,920 B1, U.S. Pat. No. 6,885,201 B2, U.S. Pat. No. 8,963,563 B2, U.S. Pat. No. 9,488,513 B2, U.S. Pat. No. 9,604,043 B2 and WO 98/003841 A1.

### SUMMARY

According to a first aspect of the present invention there is provided a fluid sensor. The fluid sensor comprises a frame, first and second electrodes supported by the frame and separated by space occupiable by a fluid and a third electrode lying in a path on the frame between the first and second electrodes.

The third electrode can be used to determine whether a surface layer of fluid is present on the fluid sensor and, thus, distinguish between the sensor being immersed in the fluid or not being immersed in the fluid, but having a surface layer of fluid and, therefore, correctly identify whether the sensor is immersed in the fluid or not.

The frame may comprise a generally planar substrate.

The frame may comprise a slot which defines a gap between first and second members, wherein the first and second electrodes are disposed on the first and second members respectively. The frame may comprise a main portion and first and second members extending from the main portion such that there is a gap between the first and second members, wherein the first and second electrodes are disposed on the first and second members respectively. The main portion and the first and second members may be a single piece.

The third electrode may be disposed on at least a part of the first or second member. The third electrode may be solely disposed or supported on the first or second member. The third electrode may be disposed or supported on the main portion. The third electrode may be solely disposed or supported on the main portion.

The fluid sensor may further comprise a fourth electrode lying in the path. The fourth electrode may be disposed at least on part of the first or second member. The fourth electrode may be solely disposed or supported on the first or second member. The fourth electrode may be disposed on the main portion. The fourth electrode may be solely disposed or supported on the main portion.

The third and fourth electrodes may be disposed on the first and second member, respectively and be separated by the gap.

The frame may comprise a printed circuit board. The sensor may comprise traces connecting electrodes to respective terminals (for example, of a circuit). At least some of the traces may be embedded in the frame. The sensor may include layers for electrically-screening embedded traces.

The first member may have a width and the first and third electrodes may extend across the majority of the width of the first member.

The first, second and third electrodes may be rectangular. An optional fourth electrode may be rectangular. The substrate may be generally ‘U’-shaped.

The fluid sensor may further comprise a coating of dielectric material. The frame and the first, second and third electrodes may be encapsulated by the coating. Thus, the fluid sensor may be fluid tight. The fluid sensor may further comprise at least one circuit supported on the substrate. The at least one circuit may include a controller, such as a microcontroller.

According to a second aspect of the present invention there is provided a sensor system comprising the fluid sensor of the first aspect, and a measurement system configured to measure an impedance, Z, between the first and second electrodes, and to measure a voltage difference, ΔV, between the third electrode and another electrode of the fluid sensor.

The other electrode may be a fourth electrode which is different from the first and second electrodes. The other electrode may be one of the first and second electrodes. The fluid sensor may include a fourth electrode. However, the other three electrodes may be used.

The measurement system may comprise a signal source arranged to apply an excitation signal to at least one electrode, an impedance measurement circuit arranged to measure the impedance, Z, between the first and second electrodes, and a voltage difference measurement circuit arranged to measure the voltage difference, ΔV, between the third electrode and the other electrode.

The impedance measurement circuit may comprise a transimpedance circuit.

The sensor system may further comprise a controller for determining whether the sensor is immersed in fluid. The controller may include the signal source.

The sensor or sensor system may include a input device, such as a push-button switch, for outputting a signal to cause a pump to activate.

According to a third aspect of the present invention there is provided a pump control system comprising at least one sensor system, and a pump controller for controlling operation of a pump, wherein the at least one sensor system is arranged to provide signal(s) to the pump controller.

The pump controller may be a switch.

According to a fourth aspect of the present invention there is provided a float switch comprising the fluid sensor of the first aspect. The float switch may take the form of a piggyback plug.

According to a fifth aspect of the present invention there is provided a pump system comprising at least one sensor system, a pump controller for controlling operation of a pump, wherein the at least one sensor system is arranged to provide signal(s) to the pump controller, and a pump arranged to be controlled by the pump controller.

According to a sixth aspect of the present invention there is provided a pump unit comprising the pump system, wherein the at least one sensors system, pump controller and pump are provided in an integrated unit, optionally, which is portable.

According to a seventh aspect of the present invention there is provided a fluid analyser comprising at least one sensor system, and a user interface configured to output signals in dependence upon the at least one sensor system. The user interface may include a display (such as an LCD, LED display or TFT display) configured to output signals in dependence upon the at least one sensor system. The display may output the name of a fluid, such as “water”, “water and oil” and/or “oil”. Other fluids may be named.

The fluid analyser may be employed to indicate the presence of contamination in a fluid, such as oil or waste matter in water.

According to eighth aspect of the present invention there is provided a method of signal processing, the method comprising receiving a first signal indicative of electrical impedance between first and second electrodes, receiving a second signal indicative of voltage difference between a third electrode and another electrode, and determining, in dependence upon the first and second signals, whether a sensor including the first, second, third electrodes and the other electrode is immersed in a fluid.

Determining whether the sensor is immersed in the fluid may comprise comparing the first and second signals against first and second threshold values, respectively. Determining whether the sensor is immersed in the fluid may comprise comparing the first and second signals against first and second functions, respectively. Determining whether the sensor is immersed in the fluid may comprise classifying the first and second signals.

According to a ninth aspect of the present invention there is provided a method of determining presence of a fluid.

According to a tenth aspect of the present invention there is provided a computer program comprising instructions for performing the method.

According to an eleventh aspect of the present invention there is provided a computer program product comprising a machine-readable medium storing the computer program.

Herein, a method is disclosed for implementing an improved capacitive fluid sensor able to detect if the capacitive signal is generated by a layer of fluid on the sensor surface rather than by a volume of fluid.

According to a twelfth aspect of the present invention there is provided a method of determining the presence of a fluid in a volume, the steps comprising (a) measuring the electrical impedance of the medium in the volume, (b) measuring a voltage difference between two electrodes, (c) comparing the electrical impedance and voltage difference with defined thresholds, and (d) determining the presence of a fluid by using the results of the measurements

The electrical impedance may be measured by applying a voltage signal to a first electrode. Said first electrode may be coupled capacitively to the medium in the volume. A current may be measured using a second electrode. The second electrode may be coupled capacitively to the medium in the volume. The current flowing into the first electrode may be measured. The impedance between the first and second electrode may be determined. The voltage drop between a third and fourth electrode may be measured. Said voltage signal may be provided by a processing unit. Said voltage signal may be provided by a signal generator. Said current and said voltages may be measured by a processing unit by means of an analogue to digital converter. Measured impedance and voltages may be used to determine the presence of a fluid in said volume. A pump may be switched on to remove said fluid. A first impedance and voltage pair may be measured at a first level and a second impedance and voltage pair are measured at a second level. The first and second pair of impedances and voltages may be used to determine if the fluid occupies the volume between the first and second level. A pump may be switched on when the fluid is above the highest of first and second level and is switched off when no fluid is detected between said first and second level. A device measuring said impedance and voltage may communicate said impedance and voltage to a second device that controls a switch. Said communication may be through a cable connecting the first and second device. Said communication may be wireless. A device measuring said impedance and voltage may determine the presence of fluid and communicates the presence of fluid to a second device that controls a switch. The switch may be used to control a pump.

According to a tenth aspect of the present invention there is provided a sensor that determine if it is partially immersed in a liquid or if it is partially coated in a liquid, the sensor comprising (a) first, second electrodes arranged with a gap, that may be occupied by liquid, between the first and second electrodes; (b) and third electrode and fourth electrodes arranged to have a bridge (directly or indirectly).

The sensor may have a complex Impedance measurement device to measure the impedance between the first and second electrode. The sensor may have a voltage difference measurement device to measure the voltage difference between the third and fourth electrodes.

### BRIEF DESCRIPTION OF THE DRAWINGS

Certain embodiments of the present invention will now be described, by way of example, with reference to FIGS. 4 to 10 of the accompanying drawings, in which:

FIG. 1 illustrates immersing a simple capacitive sensor into a fluid;

FIG. 2 illustrates removing a capacitive sensor from a fluid;

FIG. 3 shows change in capacitance over time for a simple capacitive sensor after the sensor has removed from a solution of soap and water;

FIG. 4 is a schematic diagram of a space in which a fluid may gather or be stored, a fluid level sensor and instrumentation;

FIG. 5 is a schematic diagram of a first fluid sensor which includes a set of electrodes;

FIG. 6 is a schematic diagram of a second level sensor which includes a set of electrodes;

FIG. 7 is a schematic diagram of a third level sensor which includes a set of electrodes;

FIG. 8 is an equivalent circuit for electrodes shown in FIG. 5 and circuits used to provide excitation signal to the electrodes and process measurement signals;

FIG. 9 is an equivalent circuit for electrodes shown in FIGS. 7 and 8 and circuits used to provide excitation signal to the electrodes and process measurement signals;

FIG. 10 is an example of a first circuit for converting a current received from an electrode into a voltage;

FIG. 11 is an example of a second circuit for converting a current received from an electrode into a voltage;

FIG. 12 is an example of a circuit for amplifying a voltage difference between a pair of electrodes;

FIG. 13 is schematic diagram of a look-up table storing parameter threshold values;

FIG. 14 shows plots of real and imaginary components of current and real and imaginary components of voltage for a sensor when immersed and not immersed in water;

FIG. 15 shows plots of real and imaginary components of current and real and imaginary components of voltage for a sensor when immersed and not immersed in water and in soapy water;

FIG. 16 is a side elevation of a first sensor;

FIG. 17 is a schematic cross-section taken through a first prong of the first sensor shown in FIG. 16 along the line A-A′;

FIG. 18 is a side elevation of a second sensor having an on-board controller;

FIG. 19 is schematic block diagram of a fluid level sensing system;

FIG. 20 is a process flow diagram of a method of sensing a fluid level;

FIG. 21 schematically illustrates float switch which includes a fluid sensor;

FIG. 22 schematically illustrates a water pump with an integrated fluid sensor;

FIG. 23 schematically illustrates a fluid analyser; and

FIG. 24 is an orthogonal view of a fluid sensor with annular electrodes.

### DETAILED DESCRIPTION OF CERTAIN EMBODIMENTS

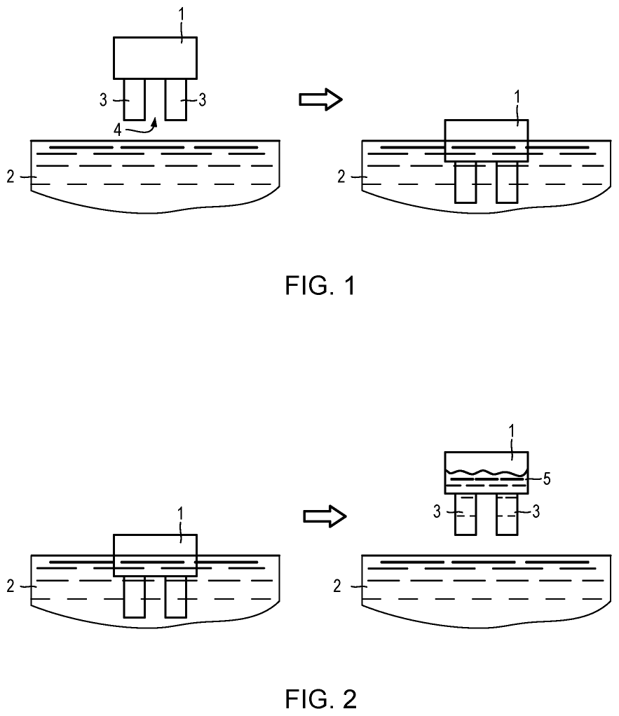

Referring to FIG. 1, a simple capacitive sensor 1 is able to detect the presence of a fluid 2 by measuring capacitance between a pair of electrodes 3. The electrodes 3 are positioned such that the electric field generated by a voltage difference between two electrodes 3 extends sufficiently into a space 4 between the electrodes 3 which is expected to be filled by the fluid 2.

When the sensor 1 (which is initially in air) is immersed in a fluid 2, the change in capacitance and/or resistance between the two electrodes 3 is detected as a change in an electrical signal, for example, current, frequency, and/or voltage.

Referring to FIG. 2, when the sensor 1 is removed from the fluid 2, it would normally be expected that the signal would quickly return to the value it had in air before the sensor 1 was immersed in the liquid. This might not happen, however, if the fluid 2 forms a layer 5 on the surface of the sensor 1 that persists after the sensor 1 is extracted from the fluid 2.

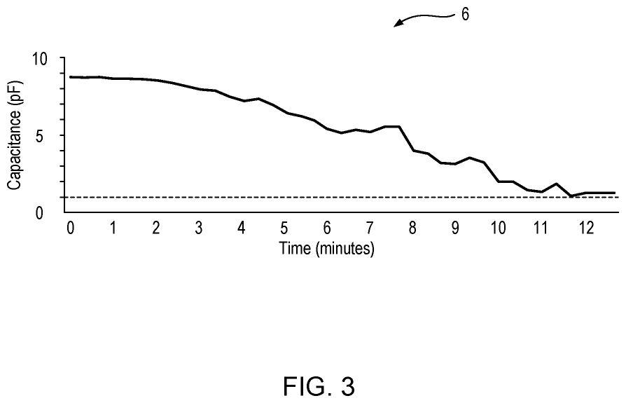

Referring to FIG. 3, a plot 6 of capacitance against time is shown.

FIG. 3 illustrates a change in capacitance over time after the simple capacitive sensor 1 is extracted from a fluid 2 in the form of a solution of soap and water. The sensor 1 is extracted from the fluid 2 at t=0. The plot 6 shows that the capacitive signal takes approximately 10 minutes to return to its original value in air, which is about 1 pF.

Examples of capacitive fluid sensors are herein described which can determine whether a capacitive signal is attributable to a layer of fluid on the surface of the sensor, rather than a volume of fluid. The sensors can be used to sense the presence of a fluid, without the need for moving parts, and can be used in a fluid pump. The sensors disclosed herein may take the form of a low-voltage (e.g., 12 V) sensor which is fully sealed against water ingress. The sensors herein described may be connected to a separate, remote pump control unit via a wired or wireless link. The sensors herein described can provide a more robust and reliable fluid presence sensor, and be one which is electrically safer.

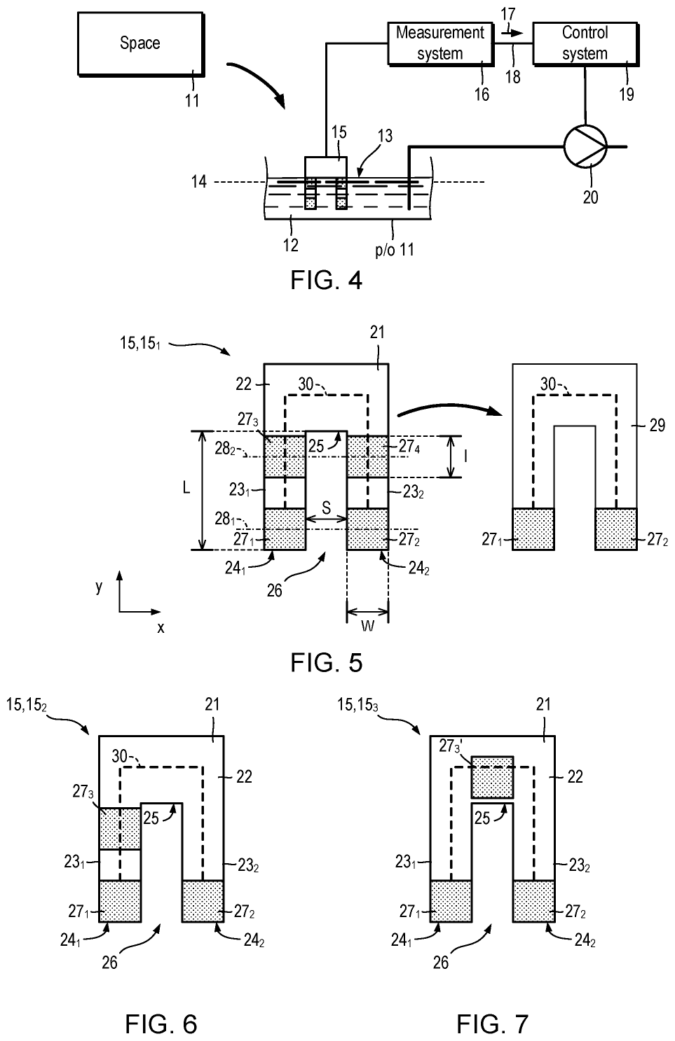

Referring to FIG. 4, a space 11 in which a fluid 12 may be present, for instance, gather, be stored or pass through, is shown.

The space 11 may take the form of a part of a building such as a cellar or the bottom of a shaft (for instance, an elevator shaft), a storage structure such as a tank, cistern or pond, a collector such as a sump (which may be in a building or vehicle), a conveyance structure such as a pipe or channel, or a vehicle such as boat. The fluid 12 may take the form of water, and may include a contaminant, such as oil or waste material (such as human waste).

When fluid 12 is present in the space 11 (for example, due to flooding), if the surface 13 of the fluid 12 rises above a given level 14 it can be sensed by a sensor 15 and measurement system 16 (which may be integrated into a single unit). The measurement system 16 may provide data 17 for example, measurements or level information, via a wired or wireless link 18 to a control system 19 which can be used to control pump 20 arranged to pump fluid 12 from the space 11.

The sensor 15 may be able to distinguish between different types of fluid 12.

Referring also to FIG. 5, the sensor 15 comprises a generally inverted ‘U’-shaped frame 21, for example in the form of printed circuit board, or other substrate which may or may not be planar, comprising a main portion 22 (or “body” or “trunk”) and two or more members 23₁, 23₂ (herein also referred to as “prongs”, “legs”, or “sides”) extending away from the body 22 towards respective distal ends 24₁, 24₂. In this case, the members 23₁, 23₂ are elongated, in other words, elongate members. In other cases, the members 23₁, 23₂ may be defined by a slot, aperture, slit or cut-out. In this case, the prongs 23₁, 23₂ extend, in parallel, from one side 25 of the body, in the same direction. The prongs 23₁, 23₂ are arranged side-by-side (in other words, transversely spaced apart) so as to define a gap 26 therebetween. Typically, the sensor 15 is arranged to be oriented so that the prongs 23₁, 23₂ depend from the body 22 and, thus, point downwards and so detect fluid 12 rising upwards.

The sensor 15 includes at least three electrodes. For example, in a first example, the sensor 15, 15₁ has four electrodes including first, second, third and fourth electrodes 27₁, 27₂, 27₃, 27₄ disposed on the prongs 23₁, 23₂. Each electrode 27₁, 27₂, 27₃, 27₄ generally takes the form of a rectangular pad which crosses the majority of the width of the prong 23₁, 23₂.

The first electrode 27₁ is disposed proximate to the distal end 24₁ of the first prong 23₁, and the second electrode 27₂ is disposed proximate to the distal end 24₂ of the second prong 23₂. The first and second electrodes 27₁, 27₂ lie on a first line 28₁ running transversely across the first and second prongs 23₁, 23₂. Herein, the first and second electrodes 27₁, 27₂ are also referred to as the “lower electrodes”.

The third and fourth electrodes 27₃, 27₄ are disposed proximate to the body 22. Thus, the third electrode 27₃ is interposed between the body 22 and the first electrode 27₁, and the fourth electrode 27₄ is interposed between the body 22 and the second electrode 27₂. The third and fourth electrodes 27₃, 27₄ lie on a second line 28₂ which is generally parallel to the first line 28₁ and which is longitudinally offset (in this orientation upwardly) from the first straight line 28₁. Herein, the third and fourth electrodes 27₃, 27₄ are also referred to as the “upper electrodes”.

The third and fourth electrodes 27₃, 27₄ lie on a path 29 running between the first and second electrodes 27₁, 27₂ through a bridge provided by the body 22. The path 29 is generally has an inverted ‘U’-shape and generally corresponds to the outline of the substrate 21 above the first and second electrodes 27₃1, 27₂. A centre line 30 of the path 29 is shown. At least a portion of third and fourth electrodes 27₃, 27₄ are disposed in the first and second prongs respectively 23₁, 23₂. In some examples, the third and fourth electrodes 27₃, 27₄ lie entirely within the length of the prongs 23₁, 23₂. In other examples, the third and fourth electrodes 27₃, 27₄ may beyond the upper end of the prongs 23₁, 23₂ and extend into the body 22.

As will be explained in more detail later, if a film of fluid 12 covers the surface of the sensor 15 covering a sufficient area of the path 29 so as to provide a low-impedance path between the first and second electrodes 27₁, 27₂, then one or more electrodes disposed on the path 29, such as the third and fourth electrodes 27₃, 27₄, can be used to detect the presence of the film of fluid 12.

Each prong 23₁, 23₂ has a width W, a length L and a thickness T. The width W may be between 0.5 cm to 1 cm, 1 cm to 2 cm, 2 cm to 4 cm, or 4 cm to 10 cm. The length L may be between 2 cm to 5 cm, 5 cm to 10 cm, 10 cm to 20 cm, or 20 cm to 50 cm. The thickness T may be between 0.5 mm to 1 mm, 1 mm to 2 mm, 2 mm to 4 mm, or 4 mm to 10 mm. Each pair of prongs 23₁, 23₂ is separated by a distance S which may be between 0.5 cm to 1 cm, 1 cm to 2 cm, 2 cm to 4 cm, or 4 cm to 10 cm. The prongs 23₁, 23₂ may be rectangular in transverse cross section, or may have another shape, such as circular (in other words, the prongs may be cylindrical).

The electrodes 27₁, 27₂, 27₃, 27₄ are covered by a dielectric layer (or “electrically-insulating layer”), such as rubber, plastic, varnish, or glass, having a thickness, for example, between 0.02 mm and 5 mm.

Referring to FIGS. 6 and 7, the sensor 15 need not have four electrodes 27₁, 27₂, 27₃, 27₄. For example, the sensor 15 may have only three electrodes 27₁, 27₂, 27₃. The third electrode 27₃ is disposed in the path 29 running between the first and second electrodes 27₁, 27₂ and preferably covers the majority of the width of the path 29.

Referring in particular to FIG. 6, a second sensor 15, 15₂ is substantially the same as the first sensor 15, 15₁ differing mainly in that it lacks the fourth electrode 27₃.

Referring in particular to FIG. 7, a third sensor 15, 15₃ is substantially similar to the as the second sensor 15, 15₃ but a third electrodes 27₃′ is not disposed in a prong 23₁, 23₂, but in the main portion 22.

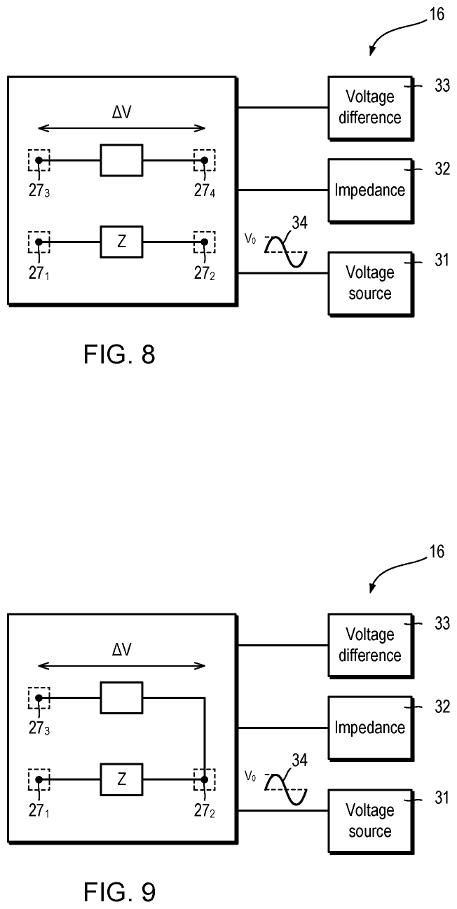

Referring to FIGS. 8 and 9, a measurement system 16 is used to apply excitation signals to the sensor 15 and measure response signals from the sensor 15.

The measurement system 16 includes a signal source 31, an impedance measurement circuit 32 and a voltage difference measurement circuit 33.

Referring to FIGS. 5, 6, 7, 8 and 9, the lower electrodes 27₁, 27 may be used to measure an impedance Z.

One of the two lower electrodes 27₁, 27₂, for example, the second electrode 27₂, may be connected to the signal source 31 in the form of a voltage source. The other electrode, for example, the first electrode 27₂, may be connected to ground. The voltage source 31 may be an ac source generating an excitation signal 34 (or “drive signal”) having an amplitude V₀, for example, between 1 mV and 100 mV, between 100 mV and 1 V, between 1V and 10 V, or larger than 10 V, and a frequency f, for example, between 100 Hz and 1 kHz, between 1 kHz and 10 kHz, or between 10 kHz and 1000 kHz). The signal 34 may take the form of a sinusoidal wave, a triangular wave, a square wave, or another waveform pattern. The source 31 may generate excitation signal 34 continuously or for a length of time T in pulses (or “bursts” or “wave trains”). The excitation signal 32 may consist of pulses having an amplitude and a duration.

The other of the two lower electrodes 27₁, 27₂ may be connected to a virtual voltage reference.

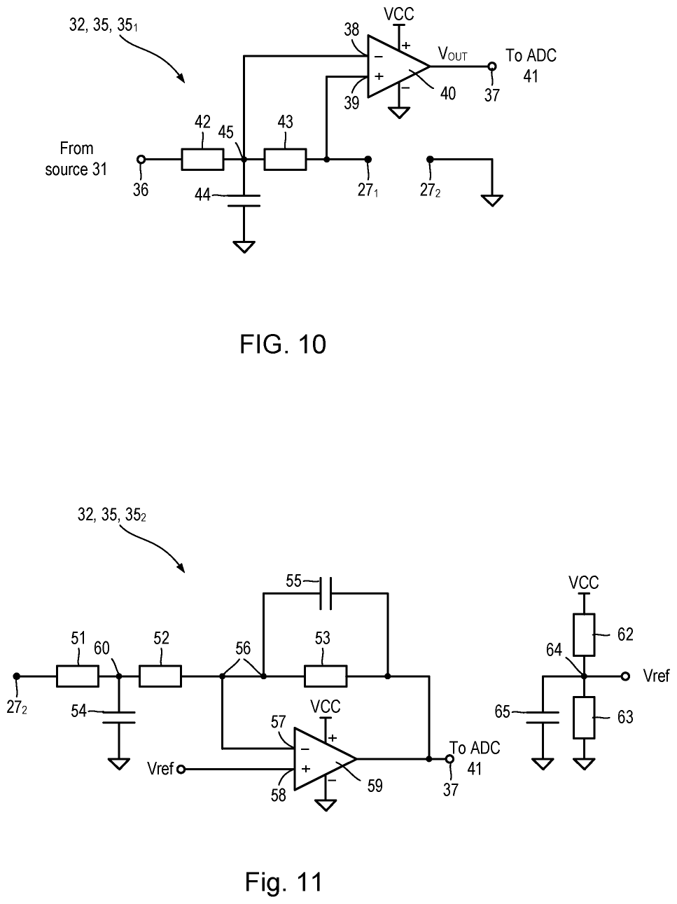

FIG. 10 shows a first transimpedance amplifier circuit 35, 351 which can serve as an impedance-measuring circuit 32. The first transimpedance amplifier circuit 35, 351 has a node or terminal 36 for receiving the excitation signal 34 which convert an input current received from the first electrode 27₁ into a proportional output voltage at node or terminal 37.

Referring also to FIG. 10, the virtual voltage reference may be the inverting input 38 of a transimpedance amplifier 40 in the form of an op-amp. The transimpedance amplifier 40 may be configured to convert an input current to an output voltage V_{OUT} with a gain, for example, between 0.01 V/μA and 0.1 V/μA, between 0.1 V/μA and 1 V/μA, between 1 V/μA and 10 V/μA. The output voltage can be provided to an input of an ADC 41.

In this example, the transimpedance amplifier circuit 35, 351 includes first and second resistors 42, 43 and a capacitor 44. The first and second resistors 42, 43 are arranged in series between the excitation signal input node or terminal 36 and one of the first and second electrodes 27₁, 27₂, in this case, the first electrode 27₁. The inverting input 38 of the amplifier 40 is connected to a first node 45 (or “tap”) between the first and second resistors 42, 43, and the capacitor 44 is connected between the first node 45 and ground. The non-inverting input 39 of the amplifier 40 is connected to the first electrode 27₁.

The first and second resistors 42, 43 and capacitor 44 may have values, for example, of 1 kΩ, 1 MΩ and 22 nF respectively, although the components 42, 43, 44 may have other values.

FIG. 11 shows another transimpedance amplifier circuit 35, 35₂ which can serve as an impedance-measuring circuit 32. The transimpedance amplifier circuit 35, 35₂.

In this example, the transimpedance amplifier circuit 35, 35₂ includes third, fourth, and fifth resistors 51, 52, 53, and second and third capacitors 54, 55. The third and fourth resistors 51, 52 are arranged in series between the second electrode 27₂ and second node 56 which is connected to the inverting input 57 of a transimpedance amplifier 59 in the form of an op-amp. The transimpedance amplifier 59 may be configured to convert an input current to an output voltage V_{OUT} with a gain, for example, between 0.01 V/μA and 0.1 V/A, between 0.1 V/μA and 1 V/μA, between 1 V/μA and 10 V/μA. The output voltage can be provided to an input of an ADC 41.

The second capacitor 54 is connected to a third node 60 between the third and fourth resistors 51, 52 and to ground. The fifth resistor 53 and the third capacitor 55 are connected in parallel between the second node 56 (and, thus, the inverting input 57) and the output 37.

A voltage reference signal Vref is provided via node or terminal 60 to the non-inverting input 58.

The voltage reference signal Vref is provided by a voltage dividing circuit 61 provided by sixth and seventh resistors 62, 63 arranged in series between a supply rail at VCC and ground in a totem pole configuration. The voltage reference signal Vref is taken by a tap 64 between the sixth and seventh resistors 62, 63. A fourth capacitor 65 is arranged in parallel with the seventh resistor 63 between the tap 64 and ground.

The third, fourth, and fifth resistors 51, 52, 53, and second and third capacitors 54, 55 may have values, for example, of 1 kΩ, 1 kΩ, 1 MΩ, 1 nF and 4.7 pF respectively, although the components 51, 52, 53, 54, 55 may have other values. The sixth and seventh resistors 62, 63 and the fourth capacitor 66 may have values of 10 kΩ, 10 kΩ and 100 nF, respectively, although the components 62, 63, 65 may have other values.

Other transimpedance amplifier circuit topologies may be used.

In yet another example, the second electrode 27₂ is connected to a voltage reference. The excitation signal 34 is routed to the first electrode 27₁ through a circuit able to measure the current, such as a shunt resistor connected to a difference amplifier, or an instrumentation amplifier, or a differential input of an ADC.

Referring again to FIGS. 5, 6, 7, 8 and 9, the impedance measuring circuits 32 hereinbefore described allow measurement of complex impedance Z between said electrodes 27₁, 27₂. The complex impedance Z is a function of the insulating material coating the electrodes and prongs, and of the medium between the two prongs 23₁, 23₂.

A measurement of impedance Z allows determination of whether the space 26 between the electrodes 27₁, 27₂ is filled with air or another fluid having a different conductivity and/or resistivity, such as water or oil.

As explained earlier, a sensor having just two electrodes might measure a value of impedance Z close to that of water even if only a thin layer of water, dirt or contamination covers the surface of the device, and the space 26 between the prongs 23₁, 23₂ is mainly filled with air. This is undesirable particularly in applications in which the measured impedance Z is used to decide whether or not to turn on a pump and thus result in dry pumping.

The third and fourth electrodes 27₃, 27₄ are connected to a circuit 33 for measuring the voltage difference ΔV between the third and fourth electrodes 27₃, 27₄. The voltage-difference measuring circuit 33 may take the form of a difference amplifier, an instrumentation amplifier, a differential input of an ADC.

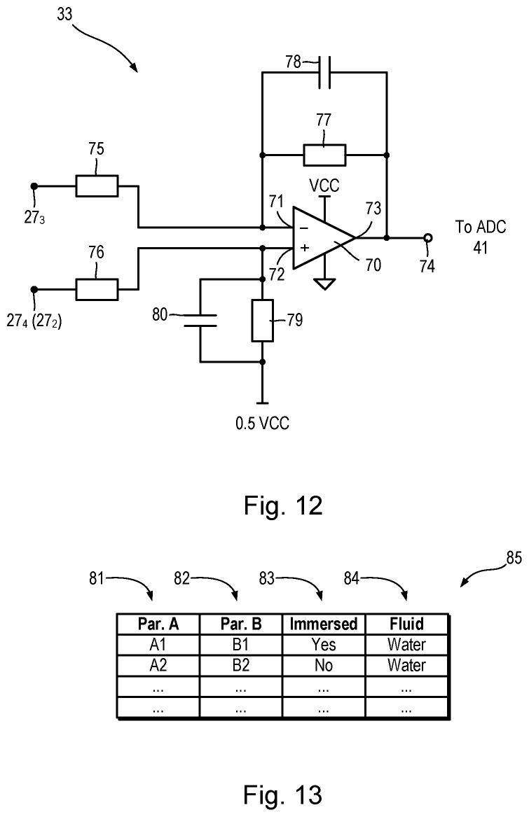

Referring to FIG. 12, an example of a suitable voltage-difference measuring circuit 33 is shown.

The circuit 33 includes a differential amplifier 70 having inverting and non-inverting inputs 71, 72 and an output 73 connected to a node or terminal 74. The third and fourth electrodes 27₃, 27₄ or, in the case that only three electrodes are used, the third and second electrodes 27₃, 27₄, are connected to the inverting and non-inverting inputs 71, 72 via eighth and ninth resistors 75, 76 respectively. The circuit 33 includes a tenth resistor 77 and a fifth capacitor 78 arranged in parallel between the inverting input 71 and the output 73. The circuit 33 includes an eleventh resistor 79 and a sixth capacitor 80 arranged in parallel between the non-inverting input 71 and a supply rail held at half the supply voltage, that is, 0.5 VCC. The circuit amplifies a voltage difference ΔV between third and fourth electrodes 27₃, 27₄ and presents an amplified signal at the node or terminal 74.

The eighth, ninth, tenth and eleventh resistors 75, 76, 77, 79 have values of, for example, 10 kΩ, 10 kΩ, 1 MΩ, and 1 MΩ, respectively, and the fifth and sixth capacitors 78, 80 have a value of 2.2 pF, although the components 75, 76, 77, 78, 79, 80 may have other values. Furthermore, other voltage different measuring circuit topologies may be used.

Referring again to FIGS. 4, 5, 6, 7, 8 and 9, when the sensor 15 is immersed in water or other fluid 12, the measured voltage difference ΔV will take a first value ΔV₁.

When a film of fluid 12 covers the surface of the sensor 15, for example, after the sensor has been removed from the bath of fluid, the measured voltage difference ΔV takes a second value ΔV₂. The first value ΔV₁ is usually smaller than the second value ΔV₁ and typically is between 0 and 0.1, between 0.1 and 0.4, or between 0.4 and 0.8 the first value, in other words 0≤ΔV₁≤0.1ΔV₂, 0.1 ΔV₂≤ΔV₁≤0.4ΔV₂, or 0.4ΔV₂≤ΔV₁≤0.8 ΔV₂. Preferably, a ratio, R, of ΔV₁/ΔV₂ (that is R=ΔV₁/ΔV₂) is between 0 and 0.8, that is, 0≤R≤0.8. Thus, ΔV₁ may take a value between being practically immeasurable to a value which is a similar, but less than ΔV₂.

The measurement of impedance Z and the measurement of the voltage difference ΔV is can be used to determine if the sensor 15 is fully or partially immersed in a fluid, or if the sensor is in air, or if the sensor is in air but a layer of a fluid or of a contaminant is present on the surface of the sensor.

Referring to FIG. 13, one or more threshold values 81 of a first parameter and one or more threshold values 82 of a second parameter which can be used to identify the state 83 of the sensor 15, for example, whether the sensor 15 is immersed or not, and/or an identifier 84 for the fluid in which the sensor is immersed. The threshold values 81, 82 may be stored in a look-up table 85.

The first parameter may be impedance or representative of impedance. The second parameter may be voltage difference or representative of difference.

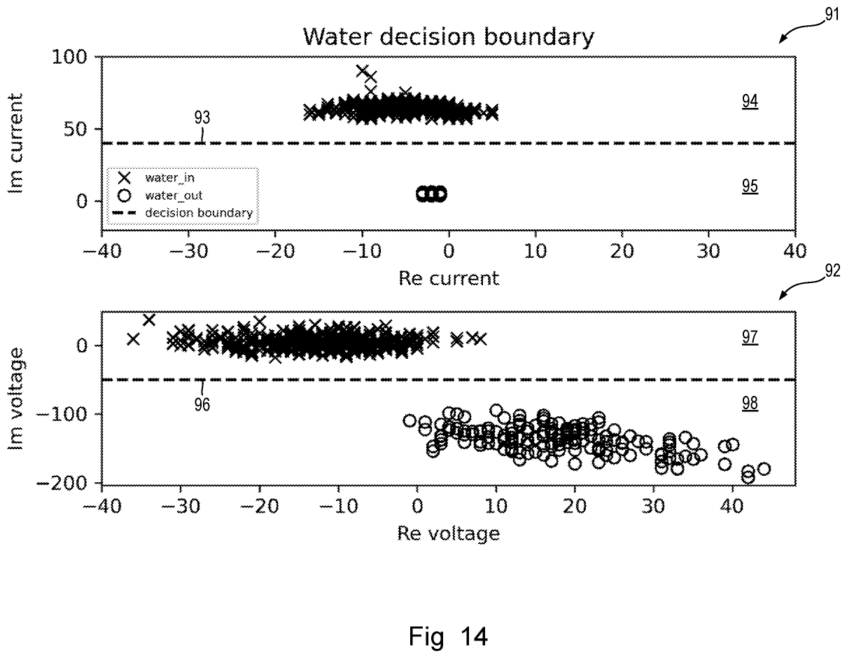

Referring to FIG. 14, first and second plots 91, 92 are shown. The current and voltage values correspond to inverse impedance (in other words, 1/Z, or admittance, Y) and ΔV measurements.

The first plot 91 contains real and imaginary values of current obtained using the first and second electrodes 27₁, 27₂ when the sensor 15 is immersed in water (shown by the symbol “×”) and when the sensor 15 is not immersed in water (shown by the symbol “o”). The second plot 92 contains real and imaginary values of voltage obtained using the third and fourth electrodes 27₃, 27₄ when the sensor 15 is immersed in water (shown by the symbol “×”) and when the sensor 15 is not immersed in water (shown by the symbol “o”).

In the first plot 91, there is a threshold value 93 of imaginary current (of around 40) which can be used divide the plot into two regions 94, 95, namely a first region 94 when the sensor 15 is immersed in water and a second region 95 when the sensor is not immersed in water. In the second plot, there is a threshold value 96 of imaginary voltage (of around-50) which can be used divide the plot into two regions 97, 98, namely a first region 97 when the sensor 15 is immersed in water and a second region 97 when the sensor is not immersed in water.

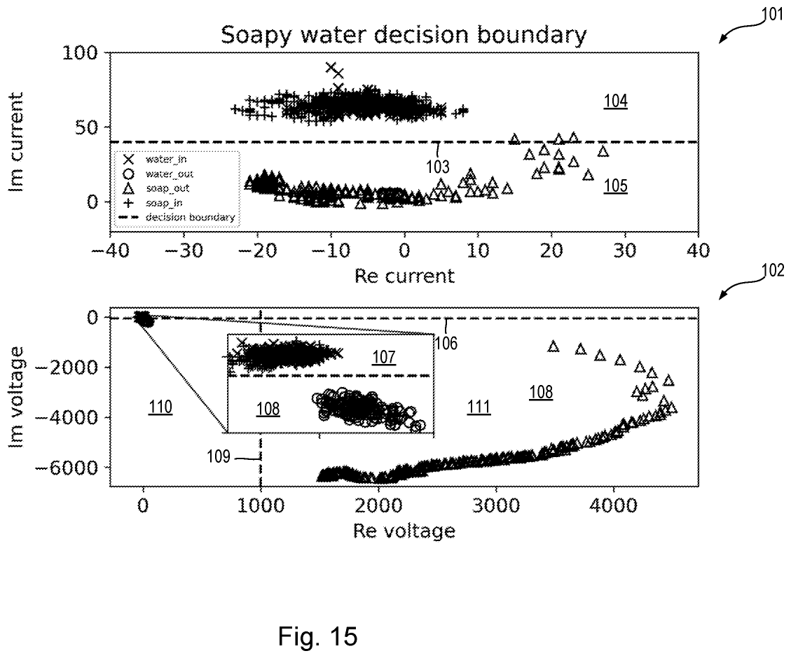

Referring to FIG. 15, third and fourth plots 101, 102 are shown.

The first plot 101 contains real and imaginary values of current obtained using the first and second electrodes 27₁, 27₂ when the sensor 15 is immersed in a solution of soap and water (shown by the symbol “+”), when the sensor 15 is not immersed in the soapy water (shown by the symbol “Δ”). The second plot 102 contains real and imaginary values of voltage obtained using the third and fourth electrodes 27₃, 27₄ when the sensor 15 is immersed in soapy water (shown by the symbol “+”) and when the sensor 15 is not immersed in soapy water (shown by the symbol “Δ”).

In the third plot 101, there is a threshold value 103 of imaginary current (of around 50) which corresponds to a threshold value of imaginary impedance and which can be used divide the plot into two regions 104, 105, namely a first region 104 (or “upper region”) when the sensor 15 is immersed in soapy water and a second region 105 (or “lower region”) when the sensor 15 is not immersed in soapy water.

In the fourth plot, there is a first threshold value 106 of imaginary voltage (of around-50) which corresponds to a threshold value of imaginary impedance and which can be used divide the plot into two regions 107, 108, namely a first region 107 (or “upper region”) when the sensor 15 is immersed in soapy water and a second region 108 (or “lower region”) when the sensor is not immersed in soapy water.

In the fourth plot, there is a second threshold value 109 (of around 1000) which can be used divide the plot into two regions 110, 111, namely a third region 110 which corresponds to a low value of ΔV (and, thus, to high resistance) when the sensor 15 is immersed or has been immersed in water, and a fourth region 111 which corresponds to a high value of (and, thus, a low resistance) when the sensor has a residual layer of soapy water.

Generally. the higher the capacitance, C, the lower the imaginary impedance, the higher the imaginary current, Im(I) and vice versa. The higher the resistance, the higher the real impedance, the lower the real current Re(I) and vice versa.

The imaginary current Im(I) reflects the capacitance attributable to the fluid, in addition to the double-layer capacitance that already exists between the electrode and medium between the electrodes. If it is assumed that water is entirely resistive and oil/air is entirely capacitive, then:

$${C}_{total} = \frac{1}{\frac{1}{{C}_{electrode}} + \frac{1}{{C}_{oil}} + \frac{1}{{C}_{electrode}}}$$

When oil is between the electrodes, the total capacitance is the sum of the reciprocal of the three capacitors. Thus, the total capacitance is lower (and the imaginary impedance is higher) and, therefore, imaginary current Im(I) is lower.

When water is between the electrodes, the total capacitance is only the sum of the reciprocal of the two electrodes. Thus, when the sensor is immersed in water, the capacitance is higher (and the imaginary impedance is lower), and therefore, the imaginary current Im(I) is higher.

The real current Re(I) provides an indication of the resistance between the electrodes.

Water has lower resistance than oil and so the real current Re(I) is higher for water.

In relation to real voltage Re(V) and imaginary voltage Im(V), when a conductive layer is present, both real and imaginary values will have higher values as they lie entirely on the current path. When the sensor is dry or immersed, the electrodes are electrically floating.

Real and imaginary values of voltages and currents can be measured with or without a surface layer of a fluid of different compositions and for when the sensor is and is not immersed. This can be used to define regions in the plots of Re(V) and Im(V), and Re(I) and Im(I) to build a map having different regions corresponding to different states of the sensor (i.e., fluid type, not immersed and dry, not immersed with fluid layer and immersed). The regions are divided by threshold values (of Re(V), Im(V), Re(I) and Im(I)) which can be used to classify the state of the sensor.

The look up table 85 (FIG. 13) may store values of real and imaginary values of current and voltage of the thresholds and, thus, be used to determine whether of not the sensors is immersed or not, if not immersed, whether it has a surface layer of fluid and, optionally, to identify the liquid.

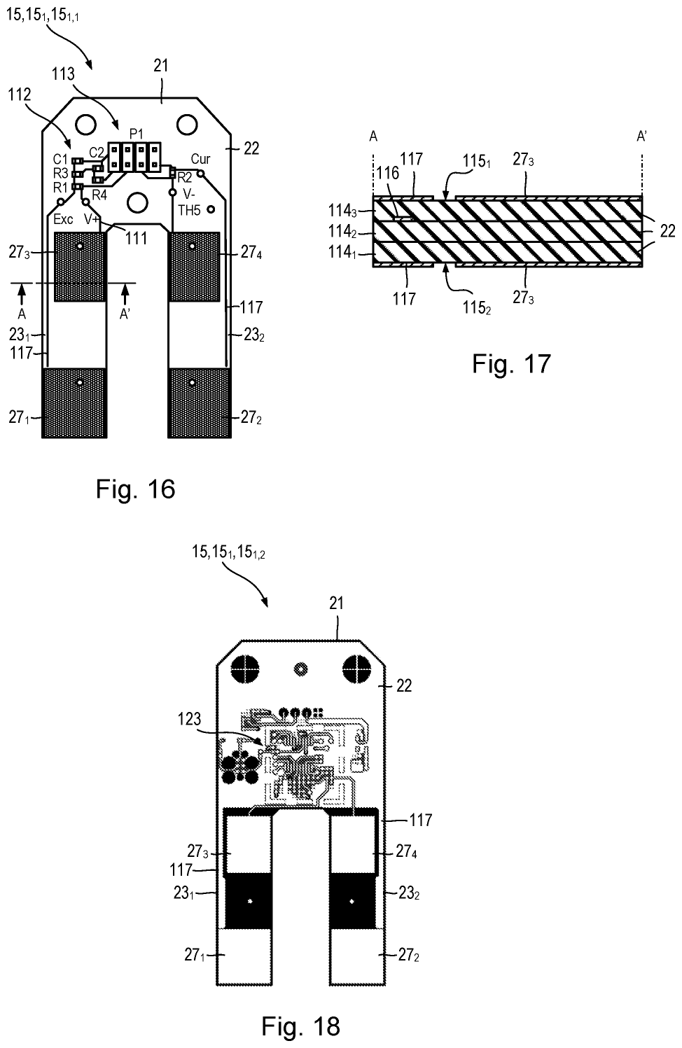

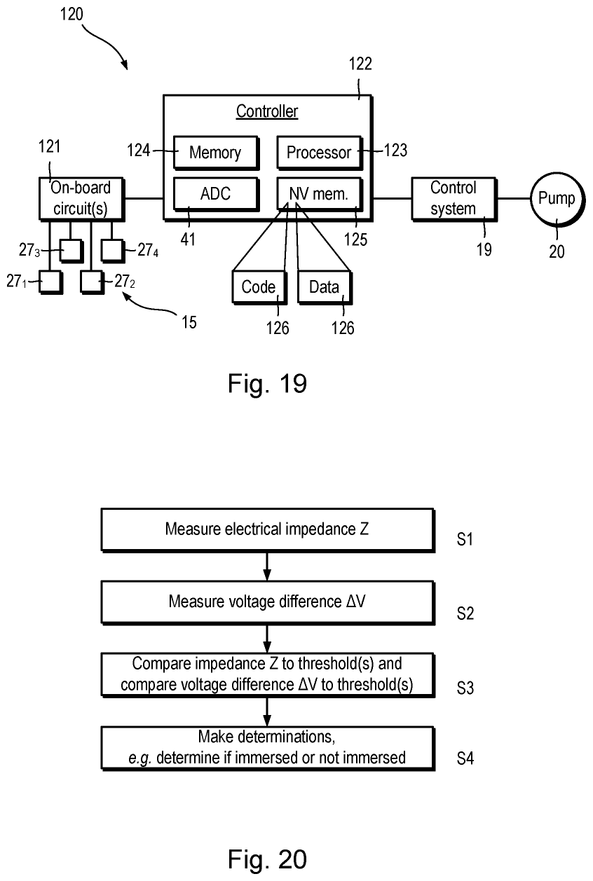

Referring to FIG. 16, a first example of a four-electrode sensor 15, 15_{1,1} is shown. The sensor 15₁ is shown without encapsulation (that is, without a dielectric coating) and any housing. The dielectric coating (not shown) may cover the substrate 21, electrodes 27₁, 27₂, 27₃, 27₄ and any on-board electronics 121 (FIG. 19) so as to make the sensor 15 fluid-tight and prevent the fluid from coming into direct contact with the electrodes 27₁, 27₂, 27₃, 27₄ and on-board electronic components.

The sensor 15 comprises a generally inverted ‘U’-shaped frame 21 comprising a printed circuit board 22 and two or more prongs 23₁, 23₂. The sensor 15 includes at least four electrodes including first, second, third and fourth electrodes 27₁, 27₂, 27₃, 27₄ disposed on the prongs 23₁, 23₂. Each electrode 27₁, 27₂, 27₃, 27₄ generally takes the form of a rectangular pad which crosses the majority of the width of the prong 23₁, 23₂.

The printed circuit board 22 supports conductive tracks 111 (or “conductive traces”), for instance tracks formed of copper or other metal, and on-board components 112 (such as resistors and capacitors) and a connector 113 for a cable (not shown).

Referring also to FIG. 17, the printed circuit board 22 may take the form of a multi-layered board comprising three or more board layers 114₁, 114₂, 114₃.

The printed circuit board 22 supports electrodes 27₃ on opposite faces 115₁, 115₂. For example, the third electrode 27₃ can be provided on opposite faces 115₁, 115₂. Conductive tracks 116 to the lower electrodes 27₁, 27₃ may be embedded in the multi-layered board 22 and conductive regions 117 may be provided on the faces 115₁, 115₂ of the board 22 running over the embedded traces to provide screening. The conductive regions 117 are electrically grounded, that is, connected to ground.

Referring to FIG. 18, a second example of a four-electrode sensor 15, 15_{1,2} is shown. The sensor 15_{1,2} is shown without encapsulation (that is, without a dielectric coating) and any housing. The dielectric coating may cover the substrate 21, electrodes 27₁, 27₂, 27₃, 27₄ and any on-board electronics 121 (FIG. 19).

The sensor 15_{1,2} is similar to the first example of the four-electrode sensor 15_{1,1} except that is arranged to support a microcontroller 122 (FIG. 19) on the body 22 in region 123. The microcontroller 120 is not shown in FIG. 18.

Sensors 15 with fewer electrodes (for example, three electrodes) or with more electrodes may support a microcontroller 122 (FIG. 19) on the body 22.

Referring to FIG. 19, a sensor system 120 is shown.

The sensor system 120 includes the sensor 15 and optionally on-board circuits 121, that is, supported on the body 22, which may include, for example, the impedance measurement circuit 32 and/or voltage difference measurement circuit 33. The controller 122 is preferably supported by the sensor 15, in other words, also is included in on-board circuits 121 (FIG. 19) so as to make the sensor 15 fluid-tight.

The system 120 includes a controller 122, for example, in the form of a microcontroller, which includes an ADC 41, a processor 123, memory 124, non-volatile memory 125 storing code 126 for processing measurement signals and configuration data 127 for example including look-up table 85 (FIG. 13).

The controller 122 may serve as the excitation source 31 (FIGS. 8 and 19). In some examples, the controller 122 may serve as the measurement circuit 32 and/or voltage difference measurement circuit 33. The sensor system 120 may be connected to a control system 19 for controlling the pump. In some examples the controller 122 provides the control system 19. The controller 122 can be used to determine if the sensor 15 is fully or partially immersed in a fluid 12, or if the sensor is in air, or if the sensor 15 is in air but a layer of a fluid or of a contaminant is present on the surface of the sensor. The controller 122 can be used to determine the type of contaminant, for example, soap, oil, waste matter and the like.

The controller 122 can be used to control a switch, which can be used to operate a motor or a pump.

At least two sensors can be used to detect the presence of a fluid in two different positions, for instance at two different levels. The sensor outputs may be used to switch on or off a pump.

The measured impedance Z and voltage difference ΔV can be used to determine if contaminants, such as oil(s), are present in the fluid 12. The measured impedance Z and voltage difference ΔV can be used to determine the type of contamination.

The sensor 15 can be incorporated into a variety of different products.

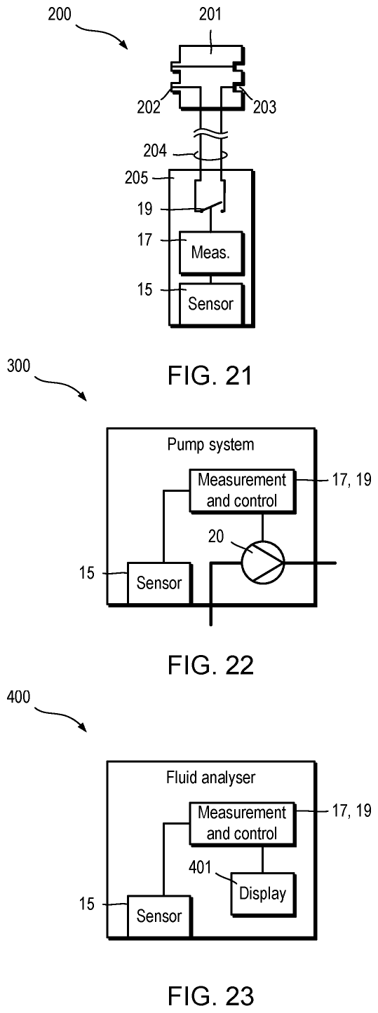

Referring to FIG. 21, a float switch 200 having a piggyback switch configuration is shown.

The float switch 200 includes a piggyback plug 201 (or switch plug) having male and female terminals 202, 203. The male terminals 202 are insertable into a power socket (not shown) and the female terminals 203 may receive a male plug (not shown) of an appliance, such as pump.

The piggyback plug 201 is connected via a cable 204 to a float switch unit 205 which includes a sensor 15, measurement system 16 and control unit 19 in the form of a switch. The float switch unit 205 may be placed, for example, on the floor or in the bottom of a sump, vessel or tank, and be used to detect the presence or absence of fluid.

Referring to FIG. 22, a pump unit 300 comprising a pump 20, a sensor 15 and measurement and control unit 17, 19 is shown.

The pump 20, sensor 15 and measurement and control unit 17, 19 are integrated into a single unit. The pump unit 300 can take the form of a drainage pump.

The sensor 15 may be provided in a deployable float switch unit (not shown) attached to a main unit (not shown) via a cable or wire-carrying tether (not shown).

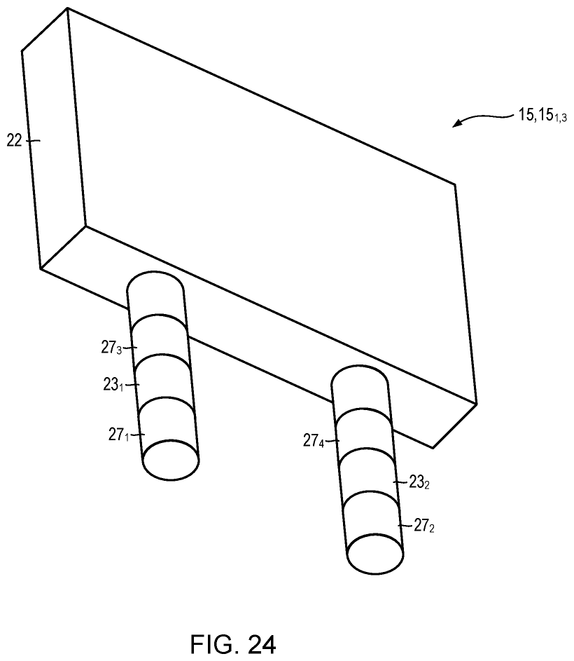

Referring to FIG. 23, a fluid analyser 400 is shown which comprises a sensor 15, measurement and control unit 17, 19 and a display 401.

The fluid analyser 400 may be used to indicate the presence of contamination in a fluid, such as oil or waste matter in water. For example, the fluid analyser 400 based on values in a look-up table 85 (FIG. 5) may identify whether the fluid 12 (FIG. 4) is one of a given number of fluids. For example, the fluids may include water, water and oil, and/or oil.

As explained earlier, the electrodes need not be planar, that is pad-like, but can take a variety of different shapes and configurations.

Referring to FIG. 24, a third example of a four-electrode sensor 15, 15_{1,3} is shown.

The sensor comprises a main body 22 and cylindrical prongs 23₁, 23₂ extending from the main body 22. Annular first, second, third and fourth electrodes 27₁, 27₂, 27₃, 27₄ are disposed on the prongs 23₁, 23₂. The third or fourth electrode 27₃, 27₄ may be omitted.

### Modifications

It will be appreciated that various modifications may be made to the embodiments hereinbefore described. Such modifications may involve equivalent and other features which are already known in the design, manufacture and use of fluid sensors and component parts thereof and which may be used instead of or in addition to features already described herein. Features of one embodiment may be replaced or supplemented by features of another embodiment.

The frame need not be thin, but can be formed in a block. The first and second electrodes may be arranged to face each other (as opposed to face outward in the same direction). The first and second electrodes may be arranged closer together, for example, on inwardly projecting jaws, so as to improve sensitivity.

There may be more than four electrodes.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A fluid sensor, comprising:
a frame;
first and second electrodes supported by the frame and separated by space occupiable by a fluid; and
third electrode lying in a path on the frame between the first and second electrodes.

2. (canceled)

3. The fluid sensor of claim 1, wherein the frame comprises a slot to define a gap between first and second members, wherein the first and second electrodes are disposed on the first and second members respectively.

4. The fluid sensor of claim 1, wherein the frame comprises a main portion and first and second members extending from the main portion such that there is a gap between the first and second members, wherein the first and second electrodes are disposed on the first and second members respectively.

5. The fluid sensor of claim 3, wherein the third electrode is disposed at least in part of the first or second member.

6. (canceled)

7. The fluid sensor of claim 4, wherein the third electrode is disposed in the main portion.

8. The fluid sensor of claim 1, further comprising:
a fourth electrode lying in the path.

9. The fluid sensor of claim 8, wherein the fourth electrode is disposed at least in part of the first or second member.

10-15. (canceled)

16. The fluid sensor of claim 1, wherein the frame is generally ‘U’-shaped.

17. The fluid sensor of claim 1, further comprising:
a coating of dielectric material;
wherein the frame and first and second electrodes and the at least third electrode are encapsulated by the coating.

18. (canceled)

19. (canceled)

20. A sensor system comprising:
the fluid sensor of claim 1; and
a measurement system configured to measure an impedance, Z, between the first and second electrodes, and to measure a voltage difference, ΔV, between the third electrode and another electrode.

21. The sensor system of claim 20, wherein the other electrode is a fourth electrode which is different from the first and second electrodes.

22. The sensor system of claim 20, wherein the other electrode is one of the first and second electrodes.

23. (canceled)

24. The sensor system of claim 20, wherein the measurement system comprises:
a signal source arranged to apply an excitation signal to at least one electrode;
an impedance measurement circuit arranged to measure the impedance, Z, between the first and second electrodes; and
a voltage difference measurement circuit arranged to measure the voltage difference, ΔV, between the third electrode and the other electrode.

25. The sensor system of claim 24, wherein the impedance measurement circuit comprises a transimpedance circuit.

26. (canceled)

27. (canceled)

28. A pump control system comprising:
at least one sensor system of claim 20; and
a pump controller for controlling operation of a pump,
wherein the at least one sensor system is arranged to provide signal(s) to the pump controller.

29. (canceled)

30. A float switch comprising the pump control system of claim 28.

31. A pump system comprising:
at least one sensor system of claim 20; and
a pump controller for controlling operation of a pump,
wherein the at least one sensor system is arranged to provide signal(s) to the pump controller; and
a pump arranged to be controlled by the pump controller.

32. (canceled)

33. A fluid analyser comprising:
at least one sensor system of claim 20; and
a user interface configured to output signals in dependence upon the at least one sensor system.

34. A method of signal processing, the method comprising:
receiving a first signal indicative of electrical impedance between first and second electrodes;
receiving a second signal indicative of voltage difference between a third electrode and another electrode; and
determining, in dependence upon the first and second signals, whether a sensor including the first, second, and third electrodes and the other electrode is immersed in a fluid.

35-37. (canceled)

38. A method of determining presence of a fluid in a volume, the method comprising:
measuring the electrical impedance of a medium in the volume;
measuring a voltage difference between two electrodes;
comparing the electrical impedance and voltage difference with defined thresholds; and
determining presence of a fluid by using the results of said comparison.

39. (canceled)

40. (canceled)
